(19) United States
(12) Patent Application Publication
(10) Pub. No.: US 2026/0176771 A1
(43) Pub. Date: Jun. 25, 2026

(54) FLUORESCENT MOIETY TAGGED POLYMERS FOR USE IN MONITORING CLEANLINESS OF MOLD SURFACES

(71) Applicant: CHEMTREAT, INC., Glen Allen, VA (US)

(72) Inventors: Patrick WOOD, Midlothian, VA (US); Robert JEFFERS, Glen Allen, VA (US); James HATCHER, Zionsville, IN (US); Alan J. FELLER, Zionsville, IN (US); James R. LAWSON, Louisville, TN (US)

(73) Assignee: CHEMTREAT, INC., Glen Allen, VA (US)

(21) Appl. No.: 19/427,133

(22) Filed: Dec. 19, 2025

Related U.S. Application Data
(60) Provisional application No. 63/736,639, filed on Dec. 20, 2024.

(51) Int. Cl. C23F 11/14; B22D 11/124; C02F 1/00; C02F 5/12; C02F 103/02

(52) U.S. Cl. CPC C23F 11/149; B22D 11/1245; C02F 1/008; C02F 5/12; C02F 2103/023; C02F 2301/046; C02F 2303/08

(57) ABSTRACT

A method of controlling the concentration of a corrosion inhibitor in closed loop cooling water includes feeding a cooling water mixture containing a corrosion inhibiting composition including at least one copper corrosion inhibiting compound and at least one tagged polymer including a fluorescent moiety in the backbone thereof, through a circulating loop that circulates the cooling water past a copper surface, and on a sample of the cooling water mixture downstream from the copper surface in the circulating loop, measuring a fluorescence signal of the sample to determine a circulating concentration of the composition in the cooling water mixture and determine what, if any, adjustment is required in concentration.

### BACKGROUND

The present invention relates to a method of controlling the concentration of an additive, such as a corrosion inhibitor, in closed loop cooling water, through the use of tagged dispersant polymers, in which the cooling water is cycled through a copper mold used in, for example, continuous casting of a metal such as steel. The tagged dispersant polymers not only enable real time monitoring of the functional effectiveness of the additive, such as a copper inhibitor, as well as the additive level within the cooling water, the polymers also serve to enhance the ability of the additive to achieve inhibition and/or removal of corrosion on the surface of a metal part that the cooling water is used to cool.

Conventionally, as an operation method of a continuous casting machine, there is known a continuous casting process in which molten metal such as molten steel is poured from a tundish into a mold, and the poured molten metal is partially cooled by the mold to solidify at least the surface of the molten metal. The mold is typically comprised of plates of a copper material when the metal being cast is steel. The cooling includes the use of cooling water fed through an open or closed loop system of pipes embedded in the mold. The cooling within the mold removes heat from the molten metal to solidify the surface of the molten metal. A semi-solidified solid product is withdrawn from the lower portion of the mold by a drawing roll, and subsequently a completely solidified solid product is produced through the use of further cooling within the machine by, for example, spray cooling.

In the continuous casting process, control of the cooling rate (i.e., heat extraction rate) through the mold is significant and requires precision control. If heat is extracted too slowly from the molten metal in the mold, a decrease in the thickness of the solidified shell of the solid product at the lower end of the mold, and an uneven distribution of the thickness of the solidified shell, will occur. As a result, a so-called breakout may occur in which the solidified shell is broken to cause leakage of molten metal upon exiting the mold. When a breakout occurs, a long down time occurs to clean and repair the continuous casting machine, and thus productivity is significantly deteriorated. On the other hand, if heat is extracted too rapidly from the molten metal while in the mold, the metal will harden too significantly before exiting the machine, and thus may become stuck within the continuous molding machine, which again causes a long down time for cleaning and repair of the continuous casting machine. In addition, inconsistent heat transfer across the mold can also lead to other defects in the cast product.

While the heat extraction rate can typically be sufficiently managed through control over the heat flux, cooling water flow, cooling water temperature, and the casting speed rate through the machine, other factors can adversely affect the cooling rate through the mold. One such factor is corrosion of the mold material, for example the formation of oxides on the cooling water side, cold face, surface of the mold.

Corrosion is caused by metals attempting to return to their natural state. Corrosion and byproducts thereof can be present in many forms, including localized or pitting, uniform metal loss, bi-metallic, galvanic, underdeposit, and microbiologically-induced corrosion (MIC). The process starts when surface irregularities, stresses, or compositional differences result in the formation of a corrosion cell (anode and cathode). Once started, corrosion at the anode causes metal to be released into the system or redeposited locally. As corrosion and byproducts precipitate on critical heat transfer devices and insulate the metals, heat transfer efficiency loss occurs.

Copper and its alloys (all referred to generally as “yellow metals”) are conventionally used as a mold material in continuous casting to form cast steel. Copper alloys are known to be susceptible to corrosion that can occur as a result of exposure of the mold surface at high temperatures to oxygenated water. In this context, copper oxidation causes the base material to change, e.g., oxidize, which also alters the thermal conductivity properties of the mold. The subsequent non-uniform heat removal alters the heat extraction rate through the mold and can lead to steel defects and increased copper mold wear.

To combat corrosion of the mold surface, a corrosion inhibiting additive is included in the cooling water. The additive is responsible for inhibiting corrosion in the system equipment and also for inhibiting formation of deposits and for preventing settling of suspended solids (dispersancy) on the system equipment, in particular the mold surface. In this role, the additive consumed. Thus, the additive is used up in inhibiting and removing corrosion products, for example including by binding with the metal of the mold that would otherwise be available to form a corrosion product on the surface of the mold. Thus, to continue effective inhibition and removal of corrosion products on the mold surface, additional amounts of the additive need to be added to the cooling water before it is fed to, or back to, the mold for cooling.

U.S. Pat. No. 5,128,065 describes a method for inhibiting the corrosion of copper or copper-bearing metals in contact with an aggressive aqueous environment comprising brackish water, salt water, or water containing brine or sulfides by forming a passive film on the surface of the metals comprising generating a water soluble copper complex consisting essentially of adding to the aggressive aqueous environment a sufficient amount for the purpose of a copper corrosion inhibitor and a chelant selected from the group consisting of ethylenediamine tetraacetic acid, the mono- or triesters of ethylenediamine tetraacetic acid, ethylenediamine mono or tricarboxylic acid, nitrilo triacetic acid or monoester thereof, citric acid, its salts and derivatives thereof, tartaric acid, its salts and derivatives thereof and dialkyldithiocarbamates.

U.S. Pat. No. 11,760,666 describes a method to reduce or eliminate N-heterocycles or adsorbable organic halides (AOX), the method providing one or more environmentally benign chelators (EBCs) to an aqueous cooling system.

What is desired is an effective method to monitor and control the amount of additive to be dosed into cooling water to maintain the ability of the cooling water to inhibit and remove corrosion products.

### SUMMARY

The present application relates to a method of controlling the concentration of a corrosion inhibitor in closed loop cooling water, comprising (a) introducing into the cooling water a corrosion inhibiting composition comprising at least one copper corrosion inhibiting compound and at least one tagged polymer comprising a polymer including a fluorescent moiety in the backbone of the polymer chain, the tagged polymer included in the composition in an amount of from about 0.01% to about 50% by weight of the composition, so as to form a cooling water mixture having an initial concentration of the composition, (b) feeding the cooling water mixture through a circulating loop that circulates the cooling water past a copper surface, (c) on a sample of the cooling water mixture downstream from the copper surface in the circulating loop, measuring a fluorescence signal of the sample to determine a circulating concentration of the composition in the cooling water mixture, and (d) if the circulating concentration is determined to be less than the initial concentration, introducing a fresh amount of the composition into the cooling water mixture downstream from the extracting of the sample and upstream from the copper surface in the circulating loop.

The composition containing the corrosion inhibitor comprises at least one copper corrosion inhibiting compound, and at least one tagged including a fluorescent moiety in the backbone of the polymer, the tagged polymer included in the composition in an amount of from about 0.01% to about 50% by weight of the composition. This composition, when included in cooling water, can be easily detected by a fluorescent detector. In this way, the amount of the additive composition remaining in the cooling water can be determined in real time, and the cooling water dosed the appropriate amount of additional additive to maintain a substantially steady state amount of the additive composition in the cooling water. The effectiveness in inhibiting and removing corrosion upon the mold surface can therefore be maximized.

The composition can thus find particular utility as an additive for cooling water supplied to a copper mold in a continuous casting process, for example a continuous casting process forming cast steel slabs. A particularly preferred use is in a closed loop system with a copper/yellow metal mold having high heat flux, the composition functioning to keep the mold clean and free of corrosion products.

The present application thus also relates to a method of controlling the concentration of a corrosion inhibiting composition in closed loop cooling water, comprising (a) introducing into the cooling water a corrosion inhibiting composition comprising at least one copper corrosion inhibiting compound and at least one tagged polymer including a fluorescent moiety in the backbone of the polymer, the tagged polymer included in the composition in an amount of from about 0.01% to about 50% by weight of the composition, so as to form a cooling water mixture having an initial concentration of the composition, (b) feeding the cooling water mixture through a circulating loop that circulates the cooling water past a copper surface, (c) on a sample of the cooling water mixture downstream from the copper surface in the circulating loop, measuring a fluorescence signal of the sample to determine a circulating concentration of the composition in the cooling water mixture, and (d) if the circulating concentration is determined to be less than the initial concentration, introducing a fresh amount of the composition into the cooling water mixture downstream from the extracting of the sample and upstream from the copper surface in the circulating loop.

### DETAILED DESCRIPTION OF EMBODIMENTS

Although specific embodiments are described herein, the scope of the invention and claims is not limited to only those specific embodiments. The scope of the invention is defined by the following claims and any equivalents therein. As will be appreciated by one skilled in the art, aspects of the present disclosure may be embodied as an apparatus, system or method.

The terms “comprise(s),” “comprising,” “include(s),” “including,” “having,” “has,” “contain(s),” “containing,” and variants thereof, as used herein, are open-ended transitional phrases, terms, or words that are meant to encompass the items listed thereafter and equivalents thereof as well as additional items. The singular forms “a”, “and”, and “the” include plural references unless the context clearly dictates otherwise. Where the term “comprising” is used, the present disclosure also contemplates other embodiments “comprising”, “consisting of”, or “consisting essentially of” elements presented herein, whether explicitly set forth or not.

Any numerical range recited herein includes all values from the lower value to the upper value. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this application.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

In general, the amount of a component in a composition as disclosed herein is expressed “by weight” which refers to the percentage of the component's weight in the total weight of the composition. Unless indicated otherwise, all concentrations are expressed as weight percentage concentrations.

The composition described herein comprises at least one copper corrosion inhibiting compound, and at least one tagged polymer including a fluorescent moiety in the backbone of the polymer chain. The tagged polymer may be included in the composition in any suitable amount, for example in an amount of from about 0.01% to about 50% by weight of the composition, including from about 1% to about 30% by weight or about 5% to about 20% by weight of the composition.

By including a fluorescent moiety in the backbone of the polymer, the fluorescence of the tagged polymer is not easily altered or destroyed, such as in the case where a fluorescent moiety is bonded to or included in the polymer in some other manner. Further, the polymer is a required component of the additive composition even if not tagged. The polymer functions with the copper corrosion inhibiting compounds to impart the ability of the additive composition to disperse copper and thereby inhibit and remove corrosion products from the surface of the copper mold. Detectable fluorescence is thus achieved in the present application without having to include any additional components to the additive composition for fluorescence. The composition is thus free of any other fluorescent materials besides the polymer.

The polymer of the tagged polymer refers to a macromolecular chain comprising repeating units. The polymer can be a homopolymer of the same repeating monomeric units, or can be a copolymer of one or more, such as two, three (e.g., terpolymers), four (e.g., quad polymers) or more different monomeric units in the chain.

The monomeric units making up the polymer chain are not particularly limited, and may include monomeric units from, for example, vinyl sulfonic acid, or vinyl sulfonates salts, vinyl phosphonic acid, or vinyl phosphonates salts, vinylidene diphosphonic acid, or salts thereof, acrylic acid, methacrylic acid, vinyl acetate, vinyl alcohol, unsaturated mono- or di-carboxylic acids or anhydrides, such as maleic anhydride, maleic acid, fumaric acid, itaconic acid, aconitic acid, mesaconic acid, citraconic acid, crotonic acid isocrotonic acid, angelic acid, tiglic acid, and the like, vinyl chloride, styrene-p-sulfonic acid, or styrene sulfonates salts, acrylamido-2-methylpropanesulfonic acid (AMPS), hydroxyphosphonoacetic acid (HPA), hypophosphorus acids such as H₃PO₃, giving units of formula —PO(OH)—, acrylamides, propargyl alcohol having formula HC═C—CH₂—OH, butyr-1,4-diol, and the like.

As described in U.S. Pat. No. 7,087,189 (incorporated herein by reference in its entirety), the polymer may include at least one monomer unit from each of dicarboxylic acids, mono-carboxylic acids, nonionic monomers, and sulfonated or sulfated monomers. The dicarboxylic monomer is one or more ethylenically unsaturated monomer containing two carboxylic acid groups, and includes aliphatic, branched or cyclic dicarboxylic acids, the alkali or alkaline earth metal or ammonium salts thereof, and the anhydrides thereof. Examples of dicarboxylic acid monomers include, but are not limited to itaconic acid, maleic acid, and maleic anhydride, citraconic acid, mesaconic acid, glutaconic acid, aconitic acid, fumaric acid, and tricarboxy ethylene, or mixtures thereof. Preferred dicarboxylic acid monomers are maleic acid or maleic anhydride. The mono-carboxylic acid monomer is one or more ethylenically unsaturated monomers having a single carboxylic acid functionality and includes aliphatic, branched or cyclic, mono-carboxylic acids, and the alkali or alkaline earth metal or ammonium salts thereof. Examples of mono-carboxylic acid monomers includes acrylic acid, methacrylic acid, ethacrylic acid, alpha-chloro-acrylic acid, alpha-cyano acrylic acid, alpha-chloro-acrylic acid, alpha-cyano acrylic acid, beta methyl-acrylic acid (crotonic acid), alpha-phenyl acrylic acid, beta-acryloxy propionic acid, sorbic acid, alpha-chloro sorbic acid, angelic acid, cinnamic acid, p-chloro cinnamic acid, beta-styryl acrylic acid (1-carboxy-4-phenyl butadiene-1,3), and mixtures thereof. The non-ionic monomer is an ethylenically unsaturated nonionic monomer including monomers represented by the chemical structure R3-X1-(CR1R2)-(CH)═(CR7)-(CR8R9)-X2-R10, wherein n1 and n2 are independently 0 to 10; R1, R2, R8 and R9 are independently hydrogen, C1-C6 alkyl, or C1-C6 alkyl-substituted aryl; R7 is hydrogen, or C1-C6 alkyl; X1 and X2 are absent or are independently O, C—O, or hydrogen; R3 is absent or is C—OR4, OR4, NR5R6, C1-C18 alkyl or hydrogen, where R4 is C1-C18 alkyl or hydrogen and R5 and R6 are independently hydrogen, C1-C6 alkyl, or an alkyloxyether or alcohol; and R10 is absent or is C—OR11, OR11, NR12R13, C1-C18 alkyl, or hydrogen, where R11 is C1-C18 alkyl or hydrogen, R12 and R13 are independently hydrogen, C1 to C6 alkyl, or an alkyloxyether or alcohol, such as C1-C6 alkyl esters of (meth)acrylic acid and the alkali or alkaline earth metal or ammonium salts thereof, acrylamide and the C1-C6 alkyl-substituted acrylamides, the N-alkyl-substituted acrylamides and the N-alkanol-substituted acrylamides. The sulfonated or sulfated monomer is one or more ethylenically unsaturated monomers containing a sulfonate functionality, such as (meth)acrylamido methyl propane sulfonic acid, styrene sulfonic acid, acrylamido alkyl or aryl sulfonic acid, allyl sulfonic acid, methallyl sulfonic acid, and salts thereof.

The polymer dispersant is effective at keeping copper soluble.

The polymer is provided with fluorescence by forming the polymer with a fluorescent monomer unit. In this manner, the fluorescent moiety is incorporated into the backbone of the polymer chain.

Any fluorescent monomers, i.e., monomers containing one or more fluorescent materials as part of the monomeric structure, may be used, so long as the monomer reacts with the other monomers to form the tagged polymer. Desirably, the fluorescent monomer does not significantly affect the water solubility of the tagged polymer, water solubility being a necessary property in order for the tagged polymer to be effective in being dispersed in cooling water.

Suitable fluorescent monomers that may be used herein include, for example, any of the fluorescent monomers described in U.S. Pat. No. 9,751,789, incorporated herein by reference in its entirety.

The amount of fluorescent monomer in the tagged polymers is in the range of from about 0.001 mole percent to about 10 mole percent, preferably from about 0.01 mole percent to about 0.4 mole percent, and most preferably from about 0.05 mole percent to about 0.35 mole percent. Herein, mole percent of all monomers in the tagged polymer is calculated based on weight percent.

The tagged polymer may have a weight average molecular weight of, for example, about 500 to about 25,000, preferably from about 500 to about 10,000.

The tagged polymer may be formed by reacting the monomers in any suitable manner.

In addition to the tagged polymer dispersant, the additive compositions herein also include a corrosion inhibitor, i.e., at least a copper corrosion inhibitor, and also other optional corrosion inhibitors, such as steel corrosion inhibitors. The copper and the steel corrosion inhibiting compounds can be any suitable compounds capable of inhibiting corrosion on the surface of the copper and/or the steel material. A single compound does not need be able to be both a copper and a steel corrosion inhibitor, and thus two or more compounds may be used in combination, with different compounds being able to be either a copper corrosion inhibitor or a steel corrosion inhibitor. Suitable examples for use in the composition include nitrites as steel corrosion inhibitors, azoles such as triazoles such as tolyltriazole (TTA), benzotriazole (BZT), methylbenzotriazole (MBT), halogen stable azole (HST), and mercaptobenzothiazole, including salts thereof, as copper corrosion inhibitors, and phosphonocarboxylate and carboxylic acids such as, for example, C6-C14 monocarboxylic acids and C6-C14 dicarboxylic acids as steel corrosion inhibitors. Heterocyclic non-triazole compounds as described in App. No. 63/541,425, incorporated herein by reference in its entirety, may also be used as a copper corrosion inhibiting compound.

A preferred copper corrosion inhibiting compound for use herein includes sodium tolyltriazole, benzotriazole, mercaptobenzothiazole and combinations thereof.

The corrosion inhibiting compound(s) may be included in the composition in a total amount of from about 0.1% to about 50% by weight of the composition, preferably from about 0.1% to about 10% by weight of the composition.

The composition may also include at least one chelating agent. The at least one chelating agent is desirably present in the composition in an amount of from 0.01% to 20% by weight of the composition. The at least one chelating agent may include any common chelating agents, for example including an aminopolycarboxylic acid, citric acid, hydroxcarboxylic acid such as citric acid and glycolic acid, and polyhydroxycarboxylic acids/sugar acids such as glucaric acid, glucoheptonate, and gluconic acid, and mixtures thereof. Preferred chelating agents are aminopolycarboxylic acids including, for example, ethylenediaminetetraacetic acid (EDTA), 1-glutamic acid, N,N-diacetic acid (GLDA), diethylenetriaminepentaacetic acid (DTPA) and methylglycinediacetic acid (MGDA). The chelating agent can be used alone or in combination of two or more. The chelating agents can be added to, for example, both solubilize and clean the copper surface of the mold.

In total, the composition may include the chelating agent and the polymer dispersant in amounts such that when the composition is added to a treatment water, a total of the chelating agent and the polymer dispersant in the treatment water is in the range of, for example, 1-1000 ppm, such as 1-500 ppm.

For measurement purposes, the amount of the tagged dispersant polymer(s) in the composition is preferably directly proportional to the amount of copper in solution in the closed loop. In this way, as the copper levels in solution increase, the fluorescent response of the tagged polymer will decrease equivalently, thereby indicating the real-time demand on the treatment for additional composition. Further, a reduction amount of the tagged polymer in the circulating composition from the corrosion inhibiting composition, i.e., the amount of product used in the contact with the copper surface, is directly proportional to the amount of oxidation and/or corrosion byproduct on the copper surface.

Preferably, the amount of the tagged dispersant polymer(s) in the composition is also proportional to the amount of chelating agent(s) in the composition.

The composition is preferably added to the cooling water in an amount such that the tagged polymer is preferably present in the cooling water in an amount from 0.1 ppm to 100 ppm, such as from 1 ppm to 50 ppm or from 5 ppm to 20 ppm.

The composition can also include water, such as distilled water and/or deionized water or RO water or city/tap water. The composition may be a dry product, supplied and/or fed as such, i.e., contain 0% by weight of water, or may include from about 10% to about 90% by weight of water. If water is included, the components of the composition should all be sufficiently water soluble to not settle out of the composition. Note that the amounts of water indicated for the composition are prior to use of the composition in subsequent copper corrosion inhibition and/or removal, where the composition may be included in a solution with water for such treatment.

In addition to the foregoing, the composition may also include additional optional additives. One such additive is a buffer such as triethanolamine or borax.

The composition may be formed in any suitable manner, for example by mixing together the various components of the composition.

The composition finds utility in inhibiting oxidation and corrosion of a copper surface and/or in removing, for example through cleaning, any oxidation and corrosion byproducts that do occur on a copper surface. As the copper of the copper surface, any copper, i.e., copper containing material, may be used. The copper may be pure copper, a copper alloy, or a metal including a measurable amount of copper.

In preferred embodiments herein, the copper is in the form of a mold for a continuous casting machine. In such molds, cooling water is provided to the side of the copper mold opposite the side in contact with the molten metal, such as molten steel, in order to extract heat from the molten metal and mold, and thereby assist in the cooling process of the molten metal as it passes through the mold.

As noted earlier, the use of cooling water, while effective for heat extraction, can also cause corrosion, oxidation and byproduct fouling on the copper surface contacted by the cooling water. Such corrosion, oxidation and related byproduct fouling can be inhibited, and if it occurs can be cleaned and removed, by application of the compositions herein to the surface of the copper.

For a cooling water solution, the composition can be added to a treatment solution in an amount of about 100 ppm to about 50,000 ppm to cooling water.

When the mold is in use in a continuous molding machine, the surface of the copper mold exposed to the cooling water may be treated by including the composition in the cooling water, at a concentration the same as the treatment solution discussed above. The cooling water, which is preferably in a closed loop recirculating system, may be continuously monitored for the amount of the composition remaining therein by utilizing the fluorescence of the tagged polymer in the additive composition, and dosed as needed with additional amounts of the composition to retain a substantially steady state amount of the composition in the cooling water fed to the mold.

With the monitoring, in real time not only can the level of additive be measured and appropriately adjusted, but also the effectiveness in function of the avoidance and removal of corrosion products such as copper oxides by the additive can be monitored. Thus, the cleanliness of the copper mold surface can be monitored in real time, and as such the detrimental effects of copper corrosion can be immediately addressed. In addition, other water quality parameters can also be monitored independent of the fluorescent polymer, such as turbidity, iron amount, copper amount, and the like, and these can be measured in real-time or intermittently during the process. Conventional measuring devices may be used in the measuring or these other water quality properties.

As noted above, in inhibiting corrosion and removing corrosion that has occurred, for example by associating with copper to maintain copper in solution and prevent formation and deposition of corrosion products such as copper oxide, the additive in the cooling water is continuously used up. It is thus necessary to continuously add additional amounts of the additive composition back into the cooling water as it circulates past the copper mold.

In order to ensure that a proper amount of additive composition is added back into the cooling water, the florescence of the tagged polymer is measured, preferably at a point in the recirculation loop downstream from where the cooling water exits from the copper mold. The detected fluorescence level is correlated to the concentration of the additive composition remaining within the cooling water. This results in the concentration of the additive composition being determined in real time.

With respect to the measuring of the sample of the cooling water mixture downstream from the copper surface in the circulating loop, a fluorescence signal of the sample may be measured either inline, for example through use of a probe known for measuring fluorescence, or a sample may be extracted from the system and subjected to a measurement, again using any suitable equipment to measure the fluorescence signal.

From the monitoring and determination of the concentration of the additive composition in the cooling water, for example from the fluorescence signal, the amount of additive composition to be added back into the cooling water is determined. Preferably, the amount added back in is an amount that returns the concentration of the additive composition back to be substantially the same as the original concentration, such that all of the additive composition used in a pass through the cooling loop is replenished. The point of addition may be downstream from the location of the monitoring, but upstream of the copper molds, so that the cooling water fed to the copper molds has an appropriate concentration of corrosion inhibiting additive therein.

Of course, as understood in the art, the circulation of the cooling water may also result in loss of volume of cooling water, for example as a result of evaporation. Additional cooling water may also be added back into the overall cooling water in the cooling loop. This additional volume of water can also be accounted for in determining the amount of additive composition to add, again so that substantially the same concentration as the initial concentration is maintained.

In the present application, methods for monitoring the fluorescence of the cooling water/additive may include any conventional monitoring equipment known in the art. One such system was described in U.S. Pat. No. 5,171,450, the entirety of which is incorporated herein by reference. In such a system, a sample of the circulating cooling water is diverted in a bypass line and fed through a fluorometer flow cell where its emissivity (em) is measured and converted to a voltage analog, including any of a DC voltage, DC current or pulsed frequency signal, convertible into a current analog signal. Emissivity and its voltage analog increase with ppm tagged polymer containing the fluorescent moiety. In this example system, a controller for controlling a feed rate of the additive into the cooling water has the capability of determining if the analog signal is above or below a set point representative of a standard predetermined feed rate. If so, then a high or low signal is transmitted to a transducer for the pump, which alters the pump rate accordingly to decrease or increase the rate of feeding the additive composition.

In the method, a preferred embodiment is to compare the determined concentration of the tagged polymer to a selected low limit set point (or selected concentration range). If the determined concentration is less than the selected low limit set point (or selected concentration range), the concentration of the additive composition in the cooling water is adjusted by adding to the cooling water fresh amounts of the additive composition.

The instrumentation for continuous monitoring includes a flow cell in the form of a quartz cylinder. The flow cell is transparent to ultraviolet light emitted by a light source directed against one side of the flow cell. At a 90° angle from the light source is a transducer which transforms fluorescent emissivity into an analog signal, emissivity varying with fluorescent concentration. An indicator responds to the output (DC) voltage of the transducer, enabling the concentration of treating agent (ppm equivalent) to be determined. There is invariably some background fluorescence in the cooling water. The amount of fluorescent tagged polymer in the cooling water is desirably sufficient to overcome this potential interference. Alternatively, the fluorescence signal of the extracted signal can be corrected for background noise and interference.

What is claimed is:

1. A method of controlling the concentration of a corrosion inhibitor in closed loop cooling water, comprising:
(a) introducing into the cooling water a corrosion inhibiting composition comprising at least one copper corrosion inhibiting compound and at least one tagged polymer comprising a polymer including a fluorescent moiety in the backbone of the polymer chain, the tagged polymer included in the composition in an amount of from about 0.01% to about 50% by weight of the composition, so as to form a cooling water mixture having an initial concentration of the composition,
(b) feeding the cooling water mixture through a circulating loop that circulates the cooling water past a copper surface,
(c) on a sample of the cooling water mixture downstream from the copper surface in the circulating loop, measuring a fluorescence signal of the sample to determine a circulating concentration of the composition in the cooling water mixture, and
(d) if the circulating concentration is determined to be less than the initial concentration, introducing a fresh amount of the composition into the cooling water mixture downstream from the extracting of the sample and upstream from the copper surface in the circulating loop.

2. The method according to claim 1, wherein the copper surface comprises a copper mold of a continuous casting machine.

3. The method according to claim 1, wherein the fresh amount of the composition into the cooling water mixture is an amount sufficient to being the circulating concentration to be substantially the same as the initial concentration.

4. The method according to claim 1, wherein the at least one copper corrosion inhibiting compound is selected from the group consisting of azole compounds, heterocyclic non-triazole compounds, and mixtures thereof, and comprises from about 0.1% to about 50% by weight of the composition.

5. The method according to claim 1, wherein an amount of the tagged polymer in the composition is directly proportional to the amount of the copper in the cooling water.

6. The method according to claim 1, wherein a reduction amount of the tagged polymer in the circulating composition from the corrosion inhibiting composition is directly proportional to an amount of oxidation and/or corrosion byproduct on the copper surface.

7. The method according to claim 1, wherein the composition further comprises at least one chelating agent included in the composition in an amount of from about 0.01% to about 20% by weight of the composition.

8. The method according to claim 7, wherein an amount of the tagged polymer in the composition is proportional to the amount of the chelating agent in the composition.

9. The method according to claim 7, wherein the at least one chelating agent is an aminopolycarboxylic acid, citric acid, and mixtures thereof.

10. The method according to claim 1, wherein the corrosion inhibiting composition further includes a steel corrosion inhibitor.

11. The method according to claim 1, wherein the corrosion inhibiting composition is introduced into the cooling water as a dry product.

12. The method according to claim 1, wherein the tagged polymer is present in the cooling water in an amount from 0.1 ppm to 100 ppm.

13. The method according to claim 1, wherein the tagged polymer is present in the cooling water in an amount from 1 ppm to 50 ppm.

14. The method according to claim 1, wherein the tagged polymer is present in the cooling water in an amount from 5 ppm to 20 ppm.
